(19) United States
(12) Patent Application Publication
(10) Pub. No.: US 2023/0189191 A1
(43) Pub. Date: Jun. 15, 2023

(54) ENABLING SERVICE CONTINUITY BETWEEN STANDALONE NON-PUBLIC NETWORK AND PLMN

(71) Applicant: IDAC Holdings, Inc., Wilmington, DE (US)

(72) Inventors: Guanzhou Wang, Brossard (CA); Saad Ahmad, Montreal (CA)

(73) Assignee: IDAC Holdings, Inc., Wilmington, DE (US)

(21) Appl. No.: 17/924,878

(22) PCT Filed: May 20, 2021
(86) PCT No.: PCT/US2021/033380

§ 371 Date: Nov. 11, 2022

Related U.S. Application Data
(60) Provisional application No. 63/028,191, filed on May 21, 2020.

(51) Int. Cl. H04W 60/04; H04W 48/18

(52) U.S. Cl. CPC H04W 60/04; H04W 48/18; H04W 84/042

(57) ABSTRACT

Systems and methods are described herein for enabling service continuity between standalone non-public network (SNPN) and a public land mobile network (PLMN). A wireless transmit/receive unit (WTRU) may enable service continuity, for example, by triggering a temporary leave of the WTRU from a serving SNPN to prepare a pre-established backup user plane (UP) connection in a PLMN. A network may enable service continuity, for example, by triggering a temporary leave of a WTRU from a serving SNPN to prepare a pre-established backup UP connection in a PLMN. A WTRU may switch back to SNPN from PLMN, for example, using an SNPN priority search mode and/or other WTRU behavior(s).

### CROSS-REFERENCE TO RELATED APPLICATIONS

The application claims the benefit of U.S. Provisional Application 63/028,191, filed May 21 2020, the contents of which are incorporated by reference in their entirety herein.

### BACKGROUND

A non-public network (NPN) may be deployed as a standalone NPN (NPN), a public network integrated NPN (PNI-NPN), and the like. A wireless transmit/receive unit (WTRU) may wish to connect to the NPN. The WTRU may wish to connect to a public land mobile network (PLMN). And the WTRU may wish to continue a service while switching between a NPN connection and an PLMN connection.

### SUMMARY

Systems, methods, and apparatus are described herein for enabling service continuity between a standalone non-public network (SNPN) and a public land mobile network (PLMN). A wireless transmit/receive unit (WTRU) may enable service continuity, for example, by triggering a temporary leave of the WTRU from a serving SNPN to prepare a pre-established backup user plane (UP) connection in a PLMN. A network may enable service continuity, for example, by triggering a temporary leave of a WTRU from a serving SNPN to prepare a pre-established backup UP connection in a PLMN. A WTRU may switch back to SNPN from PLMN, for example, using an SNPN priority search mode and/or other WTRU behavior(s).

Systems, methods, and apparatus may be provided for using a standalone non-public network (SNPN). For example, a WTRU may comprise a memory and a processor. A first protocol data unit (PDU) session with an SNPN may be determined for a service. It may be determined, based on one or more of a configuration information or a timing information, that the WTRU will be unavailable to the SNPN for a duration. A first message (e.g., a request) may be sent to the SNPN that may indicate that the WTRU is unavailable for the duration. A second message may be sent to establish a second PDU session for the service from a second network.

Systems, methods, and apparatus may be provided for using a SNPN. For example, a WTRU may comprise a memory and a processor. It may be determined that the WTRU has a first connection associated with a public land mobile network (PLMN). Subscription information may be determined. The subscription information may indicate that the WTRU has a subscription to the SNPN. Configuration information may be determined. The configuration information may indicate at least one condition for searching for the SNPN. It may be determined that the WTRU is within an SNPN coverage area when the condition for searching the SNPN has been met.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example of accessing SNPN services via a public land mobile network (PLMN).

FIG. 3 is a diagram illustrating an example of resuming SNPN service via a PLMN.

FIG. 4 is a diagram illustrating an example of pre-establishing a back-up user plane (UP) connection triggered by a WTRU.

FIG. 5 is a diagram illustrating an example of WTRU-triggered pre-establishment of a backup UP connection in a PLMN.

FIG. 6 is a diagram illustrating an example of pre-establishing a back-up UP connection triggered by a network.

FIG. 7 is a diagram illustrating an example of WTRU behavior in a SNPN priority search mode.

### EXAMPLE NETWORKS FOR IMPLEMENTATION OF THE EMBODIMENTS

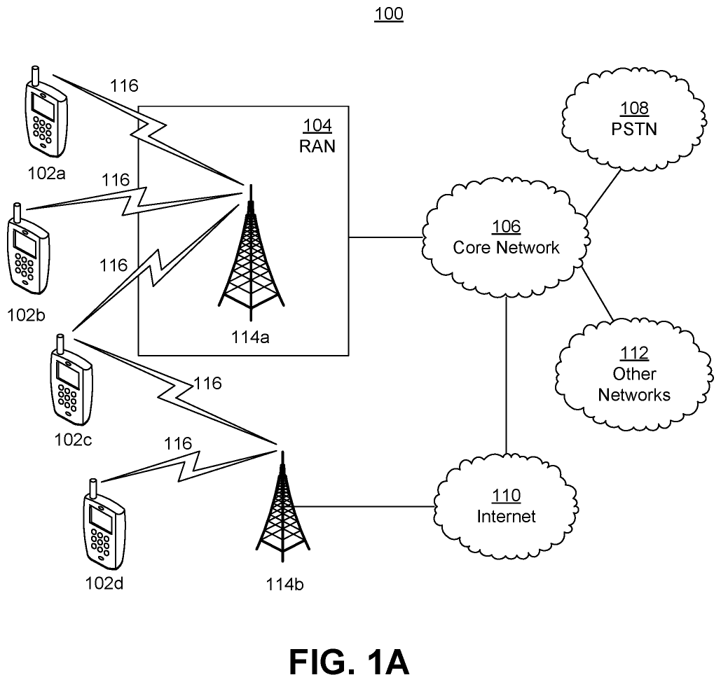

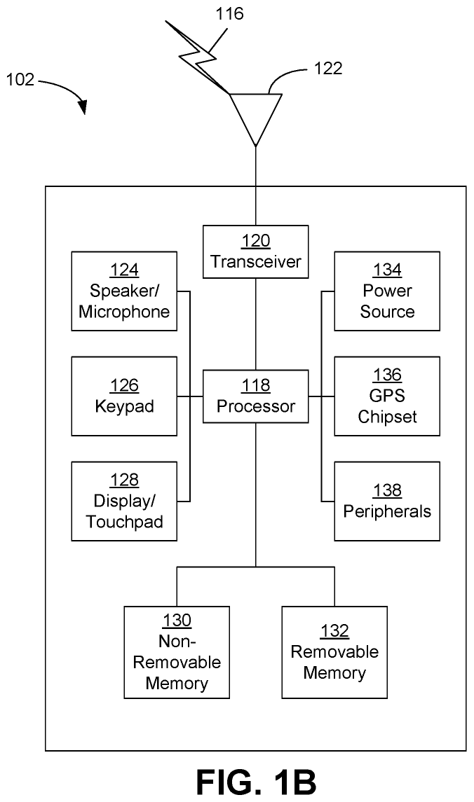

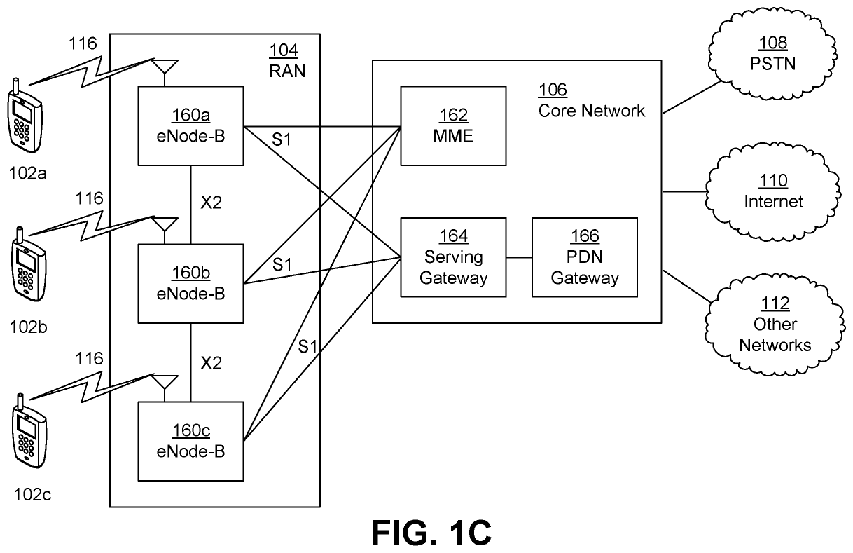

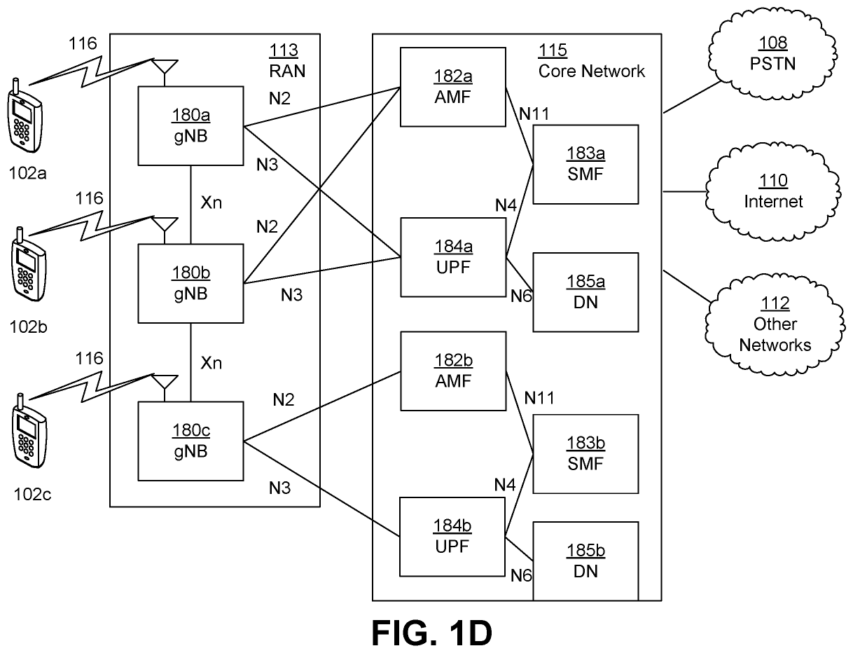

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier TDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access , which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 arid the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the aft interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802:11ah relative to those used in 802.11n, and 802.11ac, 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c, Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. in an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface,

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network shoes may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane quality of service (QoS), buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or at, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or at, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and apparatus are described herein for enabling service continuity between a standalone non-public network (SNPN) and a public land mobile network (PLMN). A wireless transmit/receive unit (WTRU) may enable service continuity, for example, by triggering a temporary leave of the WTRU from a serving SNPN to prepare a pre-established backup user plane (UP) connection in a PLMN. A network may enable service continuity, for example, by triggering a temporary leave of a WTRU from a serving SNPN to prepare a pre-established backup UP connection in a PLMN. A WTRU may switch back to SNPN from PLMN, for example, using an SNPN priority search mode and/or other WTRU behavior(s).

Systems, methods, and apparatus may be provided for using a standalone non-public network (SNPN). For example, a WTRU may comprise a memory and a processor. A first protocol data unit (PDU) session with an SNPN may be determined for a service. It may be determined, based on one or more of a configuration information or a timing information, that the WTRU will be unavailable to the SNPN for a duration. A first message (e.g., a request) may be sent to the SNPN that may indicate that the WTRU is unavailable for the duration. A second message may be sent to establish a second PDU session for the service from a second network.

Systems, methods, and apparatus may be provided for using a SNPN. For example, a WTRU may comprise a memory and a processor. It may be determined that the WTRU has a first connection associated with a public land mobile network (PLMN). Subscription information may be determined. The subscription information may indicate that the WTRU has a subscription to the SNPN. Configuration information may be determined. The configuration information may indicate at least one condition for searching for the SNPN. It may be determined that the WTRU is within an SNPN coverage area when the condition for searching the SNPN has been met.

A non-public network (NPN) may be intended for use by a private entity, such as an enterprise or a factory. An NPN may be deployed as a standalone non-public network (SNPN) or a public network integrated NPN (PNI-NPN). An SNPN may be identified, for example, by a combination of a public land mobile network (PLMN) ID and a network identifier (NID). A PLMN ID may be, for example, a reserved PLMN ID, which may be reserved for private networks (e.g., with mobile country code-999).

The architecture of a 5G SNPN may be based on, for example, the architecture of a 5G system. One or more next generation radio access networks (NG-RANs) of an SNPN may broadcast, for example, a combination of PLMN IDs and NIDs. A WTRU operating in SNPN access mode may read broadcast system information for available PLMN IDs and/or NIDs. A WTRU may select an SNPN, for example, if the WTRU has a subscription and credentials for the SNPN.

SNPN services may be accessed via a PLMN. A WTRU may access SNPN services via a PLMN, for example, by establishing user plane (UP) connectivity in the PLMN to a non-3GPP interworking function (N3IWF) of the SNPN. A WTRU may access the SNPN via the N3IWF. Protocol data unit (PDU) sessions may be established, for example, through the PLMN and SNPN N3IWF. The PDU sessions established through the PLMN and SNPN N3IWF may be considered (e.g., by the SNPN) as non-3GPP access PDU sessions.

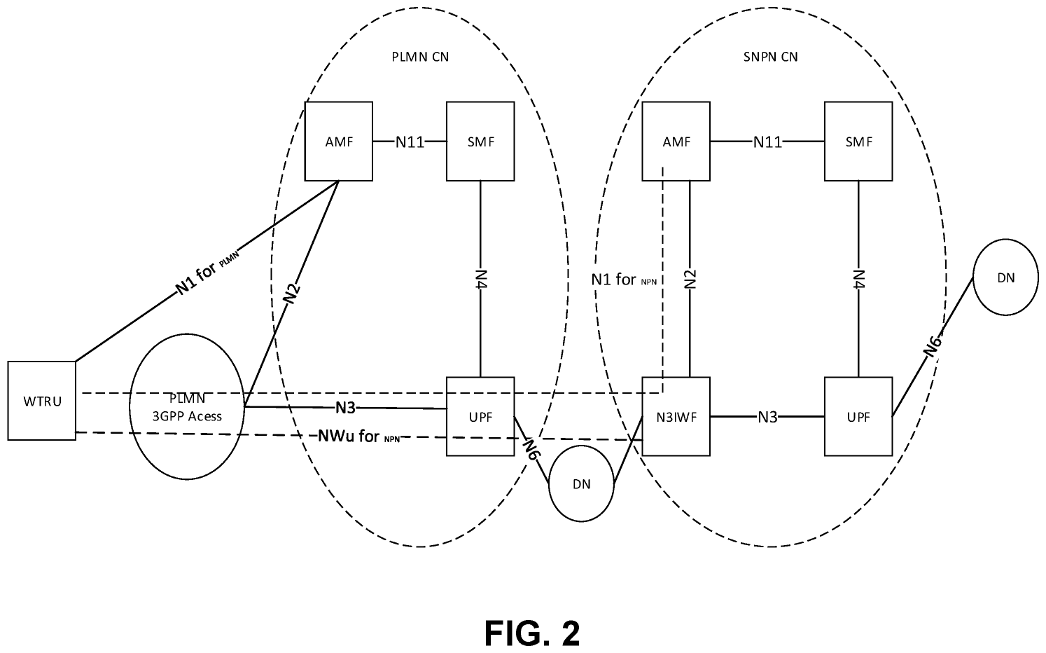

FIG. 2 is a diagram illustrating an example of accessing SNPN services via a PLMN. Service continuity may be provided between an SNPN and a PLMN. An SNPN may be co-located with one or more PLMNs, e.g., with overlapping coverage areas. A WTRU (e.g., operating in SNPN access mode) may be connected with an SNPN. The WTRU may lose SNPN coverage, for example, due to mobility. The WTRU may have access (e.g., still have access) to a PLMN. A WTRU may access the SNPN service via a PLMN, for example, by establishing user plane connectivity with the N3IWF in the SNPN.

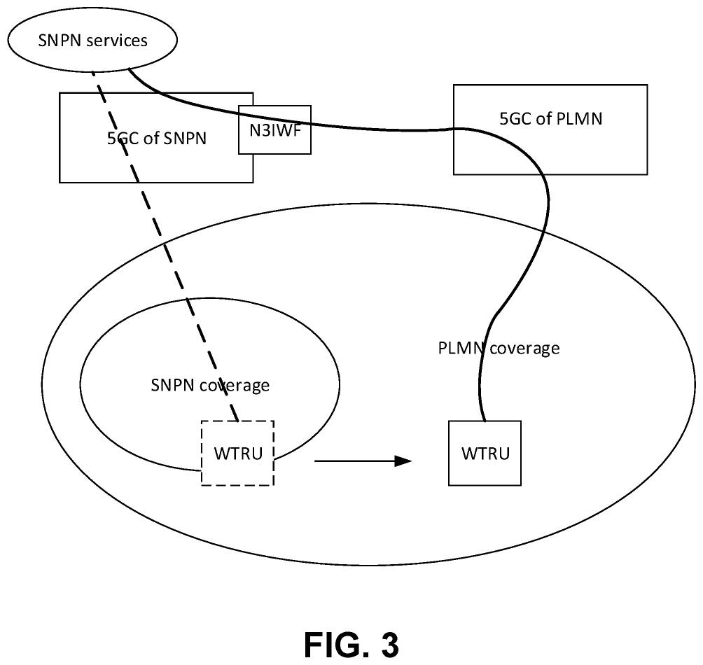

FIG. 3 is a diagram illustrating an example of resuming SNPN service via a PLMN. A WTRU may, for example (e.g., to access an SNPN service via a PLMN and use SNPN services): perform registration and authentication procedures with the PLMN (e.g., if the WTRU has not already registered with the PLMN); establish a PDU Session within a PLMN for UP connectivity with the N3IWF in SNPN; establish a secured Internet protocol security (IPSec) tunnel with the N3IWF in the SNPN; and/or establish a PDU Session via N3IWF for the SNPN service.

The procedures may introduce a delay (e.g., a significant delay) before a WTRU may resume the SNPN services via the PLMN. A delay (e.g., a significant delay) may be problematic, for example, for services (e.g., critical services) that may demand and/or request higher performance (e.g., in terms of service continuity).

A similar service interruption delay may exist in the other direction, for example, if a WTRU connected with the PLMN loses PLMN coverage and seeks to continue the PLMN service via the SNPN.

A WTRU may switch back to SNPN access mode. An SNPN capable WTRU may be in an SNPN access mode to access an SNPN, and an SNPN capable WTRU may exit SNPN access mode to access a PLMN. The details of activation and deactivation of an SNPN access mode at a WTRU may vary among WTRU implementations.

A WTRU may (e.g., in a mobility scenario) move out of SNPN coverage and seek to continue SNPN service via a PLMN. The WTRU may exit SNPN access mode, for example, in order to access a PLMN. A loss of SNPN coverage may trigger the WTRU to exit SNPN access mode.

A WTRU being served by a PLMN may return to SNPN coverage. It may be better for a WTRU to access SNPN service directly from the SNPN (e.g., instead of via a PLMN). For example, accessing SNPN services from a PLMN may incur billing charges (e.g., unnecessary billing charges) by the PLMN operator. Accessing SNPN services from a PLMN may have extra packet transmission delay (e.g., compared to accessing SNPN services directly from the SNPN). A WTRU in the PLMN coverage, which may be much larger than SNPN coverage, may not attempt to look for and reselect an SNPN. A WTRU may re-activate SNPN access mode and then re-select an SNPN.

An UP connection may be established (e.g., pre-established) in a PLMN for SNPN service. A WTRU (e.g., a single-radio WTRU) that may operate in SNPN access mode for SNPN services may leave (e.g., temporarily leave) an SNPN and switch to a PLMN, for example, that may be available in the WTRU's area. The WTRU may establish (e.g., pre-establish) a back-up UP connection in the PLMN, for example, to enable the WTRU to access SNPN services (e.g., the same SNPN services) from the PLMN (e.g., as needed) in the future (e.g., if the WTRU loses SNPN coverage due to mobility). A WTRU may switch back to an SNPN and resume SNPN services, for example, if the WTRU establishes the back-up UP connection in the PLMN.

A temporary leave or departure from the SNPN and establishment (e.g., pre-establishment) of a back-up UP connection may be triggered, for example, at the WTRU side and/or by the network.

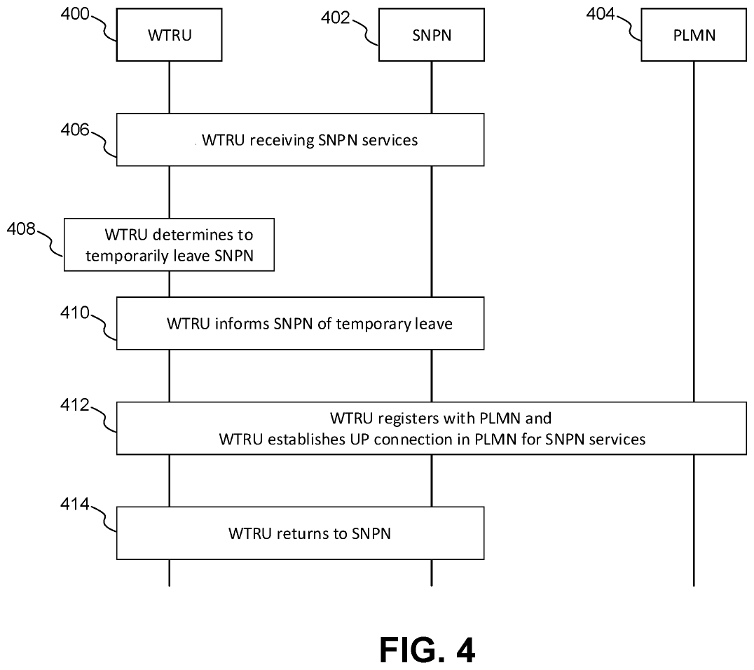

Establishment (e.g., pre-establishment) of a back-up UP connection may be triggered by a WTRU (e.g., WTRU-triggered). A WTRU may determine a need for a back-up UP connection and/or a time to temporarily leave a serving SNPN to switch to the PLMN to establish the back-up connection. The WTRU may switch back to the SNPN, for example, if the back-up connection is ready. An example of a high-level procedure is illustrated in FIG. 4.

FIG. 4 is a diagram illustrating an example of pre-establishing a back-up UP connection triggered by a WTRU. A WTRU may be pre-configured or configured by the network. Applications/services (e.g., on the network) that may demand and/or request high-performance service continuity and/or inter-network service continuity may benefit from one or more back-up UP connections in a PLMN. A WTRU may receive a configuration (e.g., and may be configured), for example, as a part of user equipment (UE) route selection policy (URSP) rules. A configuration or other indication may indicate whether one or more applications/services (e.g., as may be identified by application descriptors or data network names (DNNs)) may demand and/or request high-performance service continuity. A WTRU may receive a configuration (e.g., and may be configured), for example, as a part of a PDU session establishment accept message (e.g., during a PDU session establishment procedure for an SNPN service).

A WTRU may establish a multi-access (MA) PDU session (e.g., instead of a single access PDU Session), for example, for one or more applications/services, such as one or more services that may demand and/or request high-performance or inter-network service continuity. A WTRU may establish a backup UP connection in a PLMN, for example, as the Non-3GPP access leg of an MA PDU session for the services.

As shown in FIG. 4, a WTRU 400 may have one or more established PDU sessions in SNPN 402 (e.g., for applications/services that a configuration indicated need high-performance service continuity). At 406, the WTRU may receive SNPN services for example, through the one or more established PDU sessions. The WTRU may determine a PDU session with a SNPN for a service that may demand and/or request higher performance (e.g., in terms of service continuity). The PDU session may be a first PDU session. At 408, the WTRU may determine a time (e.g., an appropriate time) to temporarily leave the serving SNPN to establish a back-up UP connection in a PLMN 404. For example, the WTRU may determine an appropriate time (e.g., to establish a back-up connection) based on, for example, one or more of the following factors: a WTRU's connection management (CM) state, a data inactivity period, one or more radio measurements, a type of PDU session parameters, and/or one or more QoS requirements, demands, and/or requests (e.g., thresholds). As another example, the WTRU may determine that the WTRU may be unavailable to the SNPN for a duration based on one or more of a configuration information or a timing information.

A WTRU may determine an appropriate time to establish a back-up connection, for example, based on (e.g., at least in part) a WTRU's CM state. A WTRU may select an IDLE state over a connected state for a temporary leave, for example, to minimize the risk of service failure due to the WTRU's temporary non-reachability in the SNPN. A WTRU may execute a temporary leave, for example, if (e.g., or when) its RRC connection is released by an SNPN.

A WTRU may determine an appropriate time to establish a back-up connection, for example, based on (e.g., at least in part) a data inactivity period. A WTRU may (e.g., make a determination to) execute a temporary leave, for example, if the WTRU is in connected mode with a data inactivity period longer than a threshold.

A WTRU may determine an appropriate time to establish a back-up connection, for example, based on (e.g., at least in part) a radio measurement. A WTRU may (e.g., make a determination to) execute a temporary leave, for example, if a radio link measurement indicates potential degradation or loss of SNPN coverage (e.g., cell receiving level is below a threshold).

A WTRU may determine an appropriate time to establish a back-up connection, for example, based on (e.g., at least in part) the type of PDU session parameters that may be used to establish a PDU session. In examples, a single-network slice selection assistance information (S-NSSAI) or DNN may be linked (e.g., in the URSP) to a redundant PDU session (e.g., for an ultra-reliable low-latency communication (URLLC) scenario). A WTRU may establish a redundant PDU session in the PLMN. The redundant PDU session may be established, for example, via the N3IWF (e.g., as described herein).

A WTRU may determine an appropriate time to establish a back-up connection, for example, based on at least in part) a QoS threshold (e.g., a bit rate value) for one or more flows of a PDU session. A WTRU in an SNPN may monitor a QoS bit rate. A WTRU may (e.g., make a determination to) establish a backup PDU session, for example, if the QoS bit rate deteriorates below a (e.g., configured) threshold value.

As shown in FIG. 4 at 410, a WTRU may send a message (e.g., a non-access stratum (NAS) message) to a serving SNPN (e.g., to request information or to inform) about a temporary leave, for example, if the WTRU decided to leave the current SNPN to prepare a backup UP connection in a PLMN. For example, the WTRU may send a message (e.g., a request) to an SNPN that may indicate that the WTRU may be unavailable for a duration (e.g., a duration of time). A WTRU may indicate in a message, for example, that a temporary leave is for switching to a PLMN to prepare a backup UP connection. A WTRU may indicate in a message, for example, an estimated period of a leave. An SNPN may, for example, approve or reject a WTRU's indicated temporary leave (e.g., requested temporary leave), for example, in a response message. A response message (e.g., an approval message) may indicate, for example, one or more preferred network identifiers to establish a backup connection. A response message may, for example, confirm, reject, or change an expected period of temporary leave indicated by a WTRU (e.g., a response message may indicate a period of leave is the same as or different from temporary leave indicated by the WTRU).

A WTRU may exit SNPN access mode and start searching for PLMNs, for example, if a temporary leave request is approved. A WTRU may have a list of PLMN identifiers (e.g., preferred PLMN identifiers), which may be preconfigured and/or may be configured by an SNPN. A WTRU may search (e.g., try to search) and/or may select a PLMN that has the highest priority in a (e.g., preferred) network list. A WTRU may select a previously registered PLMN, for example, if the WTRU is (e.g., has previously) registered with the PLMN. A WTRU may perform a registration procedure with a selected PLMN (e.g., as shown at 412 in FIG. 4), for example, if the WTRU is not registered with the selected PLMN. As shown in FIG. 4, at 412, a WTRU may (e.g., having registered with a selected PLMN) establish one or more backup UP connections for the SNPN services (e.g., via the PLMN and the N3IWF in the SNPN). For example, a WTRU may send a message to establish a PDU session, which may be a second PDU session, for a service from a second network.

A WTRU may establish a backup UP connection, for example, as a non-3GPP access leg of an MA-PDU session. The 3GPP access leg may have already been established in the SNPN for the MA-PDU session. A WTRU may indicate this arrangement or configuration (e.g., a backup UP connection as a non-3GPP access leg of an MA-PDU session), for example, by indicating a MA PDU Request in an NAS message for a PDU session establishment request. A WTRU may use a PDU session ID the same PDU session ID) of an original PDU Session (e.g., 3GPP access leg) for the backup PDU Session. A WTRU may indicate, for example, that a PDU session is for backup or a standby purpose (e.g., to prevent the network steering data towards the backup PDU Session before it becomes active).

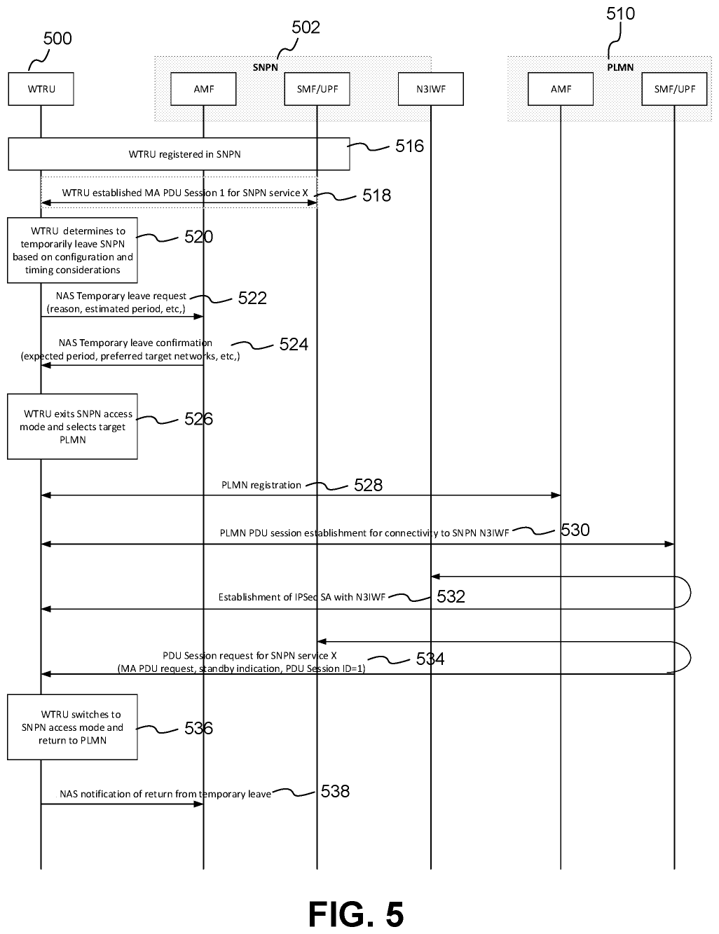

A WTRU may (e.g., after a backup PDU session is successfully established) switch back to SNPN access mode. The WTRU may re-select the SNPN that the WTRU previously registered, for example, as shown in FIG. 4 at 414. The WTRU may inform the SNPN about the WTRU's return to the network, e.g., via an NAS message. A WTRU may store a PLMN identifier (e.g., in which the WTRU has established one or more backup PDU sessions). A WTRU may indicate (e.g., mark) in the WTRU's SNPN session context, for example, whether (e.g., which) one or more PDU sessions have a backup connection in another network and (e.g., if so) a PDU Session ID of a backup connection. An example procedure is illustrated in FIG. 5.

A method and/or a WTRU may be provided for using a standalone non-public network (SNPN). A first protocol data unit (PDU) session with an SNPN for a service may be determined. It may be determined, based on one or more of a configuration information or a timing information, that the WTRU may be unavailable to the SNPN for a duration. A second message (e.g., a request) may be sent to the SNPN that may indicate that the WTRU may be unavailable for the duration. A third message may be sent to indicate that the WTRU would like to establish a second PDU session for the service from a second network.

In an example, it may be determined, based on one or more of the configuration information or the timing information, that the WTRU may be unavailable to the SNPN for the duration by determining that the WTRU may be unable to receive a downlink message from the SNPN for the duration.

In an example, it may be determined that an SNPN coverage may have been lost. A communication associated with the service may be resumed using the second PDU session.

In an example, the second network may comprise a public land mobile network (PLAIN).

In an example, the third message that may be sent to indicate that the WTRU would like to establish the second PDU session for the service from the second network may comprise an indication that the WTRU is requesting to register with the PLMN.

In an example, the third message (e.g., a request) may comprise one or more of an indication of a reason to release the first PDU session, or an indication of the duration.

In an example, a fourth message may be received. The fourth message may be a response message associated with the request.

In an example, a reason may be determined for sending the third message, which may include an indication of a request. The reason may be based on one or more of a connection management state, a data inactivity period, a radio measurement, a quality of service requirement, and a network instruction. The third message may include the reason and/or an indication of the reason.

In an example, the configuration information may indicate one or more of an application or service associated with a level of service continuity.

In an example, the second network may be determined and/or selected based on one or more of a network identifier, a SNPN configuration, and a priority network list.

FIG. 5 is a diagram illustrating an example of WTRU-triggered pre-establishment of a backup UP connection in a PLMN. Various methods are described herein. A method may comprise (e.g., may be implemented in) one or more processes or actions to achieve the described method. The order and/or use of processes and/or actions shown and/or described may vary, for example, in a different order with additional, fewer, the same and/or different actions. Reference terms such as numerals, first, second, and the like may be used in various examples to identify an element, component, action, operation, etc. Use of such (e.g., identifying) terms does not imply a required process or order of processes for a method, variations thereof, or other implementations (e.g., unless specifically required for proper operation). In examples, a first action need not be performed before a second action, and so on. In various implementations, actions may not occur, may occur out of order shown, may occur simultaneously with one or more other actions, a combination thereof, and the like.

With reference to the example shown in FIG. 5, at 516, a WTRU 500 may be registered in an SNPN 502. At 518, the WTRU may have established a multi-access (MA) PDU Session (e.g., ID=1) for SNPN service x (e.g., a PDU session with an SNPN for a service). At 520, the WTRU configuration (e.g., URSP policy) may indicate SNPN service x may demand and/or request inter-network service continuity. The WTRU may (e.g., depending on implementation) take into consideration one or more factors (e.g., as described herein). The WTRU may select an appropriate timing, for example, to initiate temporary leave from the SNPN (e.g., determine that the WTRU will be unavailable to the SNPN for a duration). At 522, the WTRU may send an NAS message to the serving SNPN. The message may request temporary leave. The message may indicate the reason for temporary leave, e.g., for preparing a backup connection in a PLMN 510. The message may indicate an estimated period of leave (e.g., a duration that the WTRU may be unavailable, for example, such that the WTRU may be unable to receive a downlink message from the SNPN for the duration). At 524, the SNPN may, for example, confirm the WTRU's request (e.g., the WTRU may receive a confirmation response message), indicate an expected period of leave, and/or indicate a list of preferred target networks for establishing backup connection(s). The network may buffer (e.g., start to buffer) incoming data for the WTRU, for example, during the expected period of temporary leave. The network may discard the buffered data, for example, if the WTRU doesn't return after an expected period. At 526, the WTRU may exit SNPN access mode and search for available PLMNs. A WTRU may, for example, prioritize the selection of a previously registered PLMN or one or more high (e.g., highest) priority target PLMN(s) that may be indicated by the SNPN (e.g., at 524). At 528, the WTRU may register with a selected PLMN (e.g., if the WTRU has not previously registered with the selected PLMN.), for example, based on sending a message to establish a PDU session for the service from the PLMN. At 530, the WTRU may establish a PDU session in the PLMN, for example, for connectivity to the SNPN N3IWF. At 532, the WTRU may establish an IPSec secure association with the N3IWF, for example, using the established PLMN PDU session. At 534, the WTRU may initiate the backup PDU session for the SNPN services X. The WTRU may indicate an MA PDU request type. The WTRU may use a (e.g., the same) PDU session ID (e.g., session ID=1) that matches the original PDU session in the SNPN. The WTRU may indicate an existing PDU session and may use a PDU session ID (e.g., the same PDU session ID) for the existing PDU session, for example, if the original (e.g., existing) PDU session was not established as an MA PDU. The WTRU may indicate, for example, that the PDU Session may be for a backup or standby purpose (e.g., to indicate that the SNPN may not prematurely steer data to the PDU session before it may be requested). The WTRU may establish backup connections for other PDU sessions in SNPN, for example, if there are multiple PDU sessions in SNPN that may demand and/or request service continuity. At 536, the WTRU may (e.g., after one or more backup connections are successfully established) re-enter SNPN access mode. The WTRU may return to a previously registered SNPN. At 538, the WTRU may notify the SNPN that the WTRU has returned. The WTRU may initiate one or more (e.g., other existing) procedures, e.g., a service request or registration update, that may (e.g., expressly or impliedly) provide notification of the WTRU's return.

A WTRU may prioritize a network selection for a PLMN among PLMNs that the WTRU may have backup connections for, for example, to re-activate one or more backup connections to continue SNPN services in the PLMN (e.g., if the WTRU loses SNPN coverage). Re-activation of a backup connection (e.g., resume a communication associated with the service using the PDU session for the PLMN) may be considered by an SNPN as an indication of the loss of SNPN access (e.g., SNPN coverage has been lost), for example, if the backup connection was established as part of an MA-PDU. The SNPN may start steering downlink data (e.g., including buffered data), for example, to the backup connection.

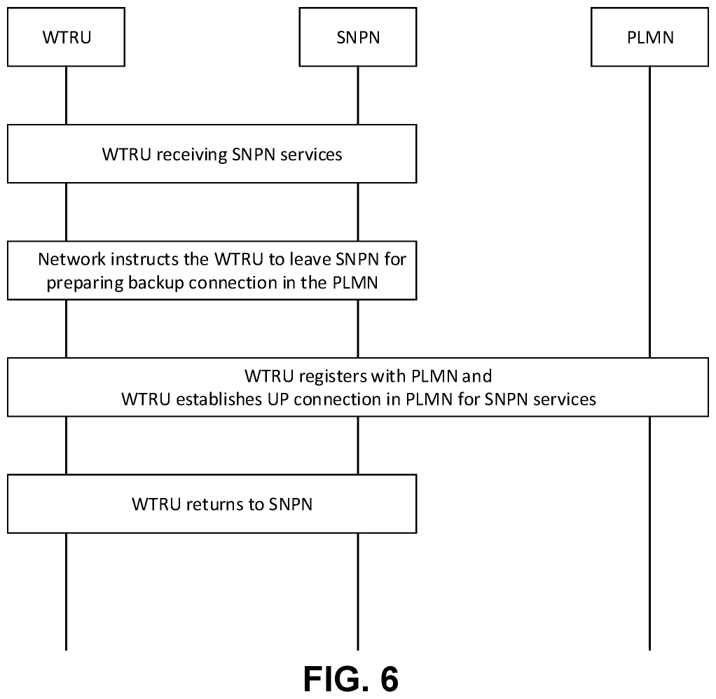

Pre-establishment of back-up UP connection may be triggered by an NW (e.g., NW-triggered). A network may determine a need and a time for a WTRU to temporarily leave a serving SNPN and switch to a PLMN to establish a back-up connection. An example of a (e.g., high-level) procedure is illustrated in FIG. 6.

FIG. 6 is a diagram illustrating an example of pre-establishing a back-up UP connection triggered by a network. A network may determine that a WTRU should prepare one or more backup connections in a PLMN, for example, based on one or more (e.g., a combination) of the following information. A WTRU's subscription data and/or capability information (e.g., received from a WTRU) may indicate whether the WTRU is capable of preparing and utilizing one or more backup connections in PLMN and/or whether the WTRU can establish redundant PDU sessions. A service requirement (e.g., policy information that may be received from a policy server) related to a WTRU's established PDU sessions or active services may indicate, for example, whether a service has a high performance or inter-network service continuity requirement.

A network may determine the timing for a WTRU to temporarily leave an SNPN (e.g., to prepare one or more backup connections) based on, for example, one or more (e.g., a combination) of the following factors: whether the WTRU is in the IDLE state; whether the WTRU is in the connected state with data activity inactive for a threshold amount of time; whether the WTRU's location indicates the WTRU may be on the border of SNPN coverage; whether the WTRU's measurement report indicates a potential degradation or loss of radio coverage; and whether the network may trigger end to end QoS monitoring, The network (e.g., a session management function (SMF)) may send (e.g., decide to send) a message (e.g., an explicit message) from the network, for example, based on QoS monitoring. The network may send a message (e.g., an NAS message), for example, to suspend the connection and inform (e.g., instruct) the WTRU to establish a backup connection in the PLMN. The NAS message may be, for example, a session management message or a mobility management message. The network may request a user plane function (UPF), for example, to buffer data while the WTRU is establishing a connection in the PLMN.

A network may instruct a WTRU to temporarily leave the network, for example, for the purpose of preparing a backup connection in a PLMN. The network may (e.g., if the WTRU is in IDLE state), for example, page the WTRU and send the WTRU a message (e.g., an NAS message). The network may (e.g., if the WTRU is in connected state), for example, release the RRC connection and indicate the temporary leave in the release message. The network may indicate, for example, one or more of the following information: a reason for temporary leave (e.g., for the preparation of one or more UP connections in the PLMN); an expected period of temporary leave; a list of PDU session IDs for which the backup UP connections may be established; and/or a list of (e.g., preferred) networks identifiers the WTRU may select after leaving the SNPN.

A WTRU may (e.g., after receiving an instruction from the SNPN) exit SNPN access mode, search for, and select one or more PLMNs. An example network-triggered procedure may be similar to the WTRU-triggered procedure.

A back-up UP connection may be released, for example, by a network. For example (e.g., on the network side), a PDU session (e.g., which may have a backup PDU session) may be released. The network may release (e.g., simultaneously release) the UP resources of the backup connection corresponding to the released PDU session. For example (e.g., on the network side), a PDU session (e.g., which may have a backup PDU session) may be released. The WTRU may consider (e.g., locally consider) the corresponding backup PDU session to be released.

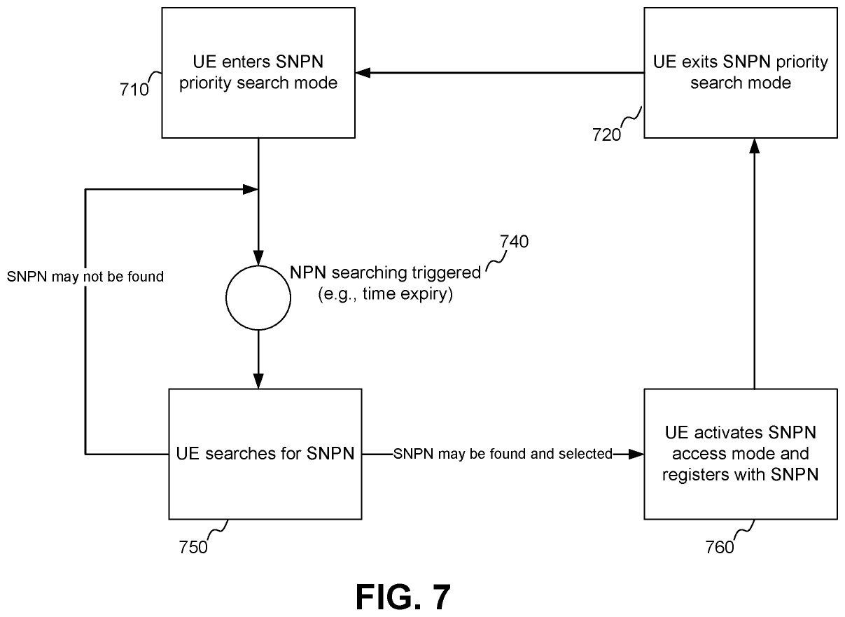

A WTRU may engage in SNPN selection when moving back in to SNPN coverage. FIG. 7 is a diagram illustrating an example of WTRU behavior in SNPN priority search mode. A WTRU (e.g., an SNPN capable WTRU registered in a PLMN) may try to re-select an SNPN, for example, using one or more of the following methods. An SNPN capable WTRU may be configured (e.g., in WTRU memory, such as a subscriber identity module (SIM)/universal subscriber identity module (USIM) or other volatile memory, or in mobile equipment (ME)) with a rule or indication that the WTRU should attempt to select (e.g., search for) an SNPN (e.g., by re-selecting a previously registered SNPN or other SNPN for which the WTRU has the subscriber data), for example, if the WTRU is registered and camping in other non-SNPN (e.g., a PLMN). A configuration may be pre-configured in the WTRU, configured by a registered SNPN (e.g., during a registration procedure), and/or manually configured by the user. As shown in FIG. 7 at 710, a WTRU may (e.g., if a configuration is present) enter an SNPN priority search mode (e.g., determine that a condition for searching for an SNPN has been met), for example, if one or more of the following occurs: the WTRU has deactivated SNPN access mode (e.g., due to loss of SNPN coverage or user manual selection); and/or the WTRU has selected a non-SNPN (e.g., a PLMN) and successfully registered with the network (e.g., determine that the WTRU has a connection with the PLMN.

As shown in FIG. 7 at 720, a WTRU may exit SNPN priority search mode, for example, if the WTRU switches back to an SNPN. SNPN priority search mode may apply to IDLE mode. A WTRU may refrain from searching for an SNPN, for example, if the WTRU enters connected mode in a non-SNPN (e.g., a PLMN).

A WTRU may enter an SNPN priority search mode, for example, if the WTRU was previously registered with an SNPN (e.g., WTRU has a subscription to the SNPN) before selecting another non-SNPN (e.g., PLMN). The WTRU may store (e.g., in WTRU memory) information of or about the SNPN (e.g., a network identifier of the SNPN) that it previously registered with.

As shown in FIG. 7 at 730, a WTRU may (e.g., in SNPN priority search mode) attempt to search for and re-select a SNPN, for example, based on one or more of the following. A WTRU may search for an SNPN, for example, at one or more time intervals (e.g., configured time intervals). A WTRU may track a time period (e.g., start a timer), for example, after the WTRU enters an SNPN priority search mode. As shown in FIG. 7 at 740, a WTRU may initiate an SNPN search procedure, for example, if the time period elapses (e.g., the timer expires). A time period may be reset (e.g., via a timer), for example, if an SNPN (e.g., any or at of the SNPNs) for which the WTRU has subscriber data cannot be found. The WTRU may use a time period associated with a (e.g., periodical) location/registration update (e.g., via a timer) that may be configured for the current registered network (e.g., a PLMN) as a period of time (e.g., via a timer) for triggering an SNPN search procedure. A WTRU may start an SNPN search procedure before a (e.g., periodical) location/registration update procedure. A WTRU may refrain from performing a (e.g., periodical) location/registration update procedure, for example, if an SNPN is found and selected.

A WTRU may search for an SNPN, for example, if a cell reselection procedure is triggered for a currently registered network (e.g., a PLMN). A WTRU may (e.g., first) start searching for an SNPN (e.g., instead of searching for other suitable cells of a currently registered network), for example, if a cell Rx level (e.g., reference signal received power (RSRP)) and/or a cell quality level (e.g., reference signal received quality (RSRQ)) drop below a certain levels) (e.g., threshold level(s)), which may trigger a cell reselection procedure. A WTRU may resume a cell selection evaluation and selection process for a currently registered network, for example, if none of the SNPNs that the WTRU has subscriber data for (e.g., if any) is found.

A WTRU may search for an SNPN, for example, if the WTRU receives a registration reject from a currently selected network, or if the WTRU exits connected mode (e.g., upon receiving an RRC release command from the network).

A WTRU may remain in none-SNPN access mode or may switch to an SNPN access mode, for example, if the WTRU starts searching for an SNPN. A WTRU (e.g., that switched to SNPN access mode to perform SNPN searching) may switch back to non-SNPN access mode, for example, if an SNPN is not found and selected.

One or more SNPNs (e.g., that a WTRU has subscriber data for) may be found. A WTRU may, for example, present the detected SNPN(s) to the user and wait for user interaction to determine whether to select an SNPN and/or which SNPN to select. A WTRU may select (e.g., automatically select) a found/detected SNPN (e.g., a previously registered SNPN), for example, without waiting for user instruction. As shown in FIG. 7 at 760, a WTRU may (e.g., if an SNPN is selected) switch to (e.g., activate) SNPN access mode (e.g., if the WTRU is not in SNPN access mode) and perform registration with the selected SNPN.

A method and/or a WTRU may be provided for using a standalone non-public network (SNPN). It may be determined that the WTRU has a first connection associated with a public land mobile network (PLMN). It may be determined that a subscription information that indicates that the WTRU has a subscription to the SNPN. A configuration information that indicates at least one condition for searching for the SNPN may be determined. It may be determined that the WTRU is within an SNPN coverage area when the condition for searching for the SNPN has been met.

In an example, the WTRU may be switched and/or configured (e.g., by a processor) to an SNPN mode when the condition for searching for the SNPN has been met.

In an example, a message may be sent to the SNPN to register a second connection associated with the SNPN.

In an example, the configuration information may further indicate that the WTRU may enter an SNPN priority search mode.

In an example, searching for the SNPN may comprise a determining that a time period has elapsed. For example, a search for the SNPN may occur after the time period has elapsed.

In an example, the time period may be associated with a location update procedure for the PLMN and/or a registration update procedure for the PLMN.

In an example, a condition for searching for the SNPN may comprise one or more of a cell reception level that is below a first threshold, and a cell quality level that is below a second threshold.

In an example, a condition for searching for the SNPN may comprise receiving a message indicating that a registration request from the WTRU has been rejected.

In an example, the first connection may be a user plane, UP, connection, and the condition for searching for the SNPN may comprise receiving a message indicating that the UP connection in the PLMN is to be released.

In an example, the condition for searching for the SNPN may comprise determining that the first connection is idle.

Although features and elements described above are described in particular combinations, each feature or element may be used alone without the other features arid elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-20. (canceled)

21. A wireless transmit/receive unit (WTRU) comprising:
a processor and memory, the processor and memory configured to:
register with a public land mobile network (PLMN) and camp on a cell of the PLMN;
determine configuration information for searching for cells of a non-public network, wherein the configuration information indicates one or more triggers for searching for the cells of the non-public network when the WTRU is in idle mode and camped on a cell of the PLMN;
determine that at least one of the one or more triggers for searching for the cells of the non-public network has occurred while the WTRU is in idle mode and camped on the cell of the PLMN; and
search for the cells of the non-public network based on the determination that the at least one of the one or more triggers has occurred.

22. The WTRU of claim 21, wherein the processor and memory are configured to prioritize searching for the cells of the non-public network upon determining that the at least one of the one or more triggers has occurred.

23. The WTRU of claim 22, wherein the processor and memory are configured to refrain from searching cells of the PLMN when prioritizing searching for the cells of the non-public network.

24. The WTRU of claim 22, wherein the processor and memory are configured to:
determine that a suitable non-public network cell was not found in a period of time after initiation of the search for the cells of the non-public network; and
initiate a search for cells of the PLMN based on a determination that a suitable non-public network cells was not found.

25. The WTRU of claim 21, wherein the non-public network is a standalone non-public network.

26. The WTRU of claim 21, wherein the one or more triggers for searching for the cells of the non-public network occurs upon the elapse of a determined time period.

27. The WTRU of claim 26, wherein the determined time period is associated with a location update or a registration update that is configured for the PLMN.

28. The WTRU of claim 21, wherein the one or more triggers for searching for the cells of the non-public network occurs if a cell receive power level drops below a threshold level or if a cell quality level drops below a threshold level.

29. The WTRU of claim 21, wherein the processor and memory are further configured to:
detect one or more non-public networks;
present the one or more detected non-public network to a user; and
wait for the user to select a non-public network from the one or more non-public networks.

30. The WTRU of claim 21, wherein the processor and memory are further configured to:
detect one or more non-public networks;
activate an access mode that selects a non-public network from the one or more non-public networks; and
register the WTRU with the selected non-public network.

31. A method implemented by a wireless transmit/receive unit (WTRU), the method comprising:
registering with a public land mobile network (PLMN) and camp on a cell of the PLMN;
determining configuration information for searching for cells of a non-public network, wherein the configuration information indicating one or more triggers for searching for the cells of the non-public network when the WTRU is in idle mode and camped on a cell of the PLMN;
determining that at least one of the one or more triggers for searching for the cells of the non-public network has occurred while the WTRU is in idle mode and camped on the cell of the PLMN; and
searching for the cells of the non-public network based on the determination that the at least one of the one or more triggers has occurred.

32. The method of claim 31, the method comprising searching for the cells of the non-public network upon determining that the at least one of the one or more triggers has occurred.

33. The method of claim 32, the method comprising refraining from searching cells of the PLMN when prioritizing searching for the cells of the non-public network.

34. The method of claim 32, the method comprising:
determining that a suitable non-public network cell was not found in a period of time after initiation of the search for the cells of the non-public network; and
initiating a search for cells of the PLMN based on a determination that a suitable non-public network cells was not found.

35. The method of claim 31, wherein the non-public network is a standalone non-public network.

36. The method of claim 31, wherein the one or more triggers for searching for the cells of the non-public network occurs upon the elapse of a determined time period.

37. The method of claim 36, wherein the determined time period is associated with a location update or a registration update that is configured for the PLMN.

38. The method of claim 31, wherein the one or more triggers for searching for the cells of the non-public network occurs if a cell receive power level drops below a threshold level or if a cell quality level drops below a threshold level.

39. The method of claim 31, wherein the processor and memory are further configured to:
detecting one or more non-public networks;
presenting the one or more detected non-public network to a user; and
waiting for the user to select a non-public network from the one or more non-public networks.

40. The method of claim 31, wherein the processor and memory are further configured to:
detecting one or more non-public networks;
activating an access mode that selects a non-public network from the one or more non-public networks; and
registering the WTRU with the selected non-public network.
